(19) United States
(12) Patent Application Publication
(10) Pub. No.: US 2021/0152916 A1
(43) Pub. Date: May 20, 2021

(54) Wireless Earbud System

(71) Applicant: Allen Kohler, Thornton, CO (US)

(72) Inventor: Allen Kohler, Thornton, CO (US)

(21) Appl. No.: 16/952,652

(22) Filed: Nov. 19, 2020

Related U.S. Application Data
(60) Provisional application No. 62/937,466, filed on Nov. 19, 2019.

(51) Int. Cl. H04R 1/10; H04W 76/10; H04R 1/08; H04M 19/04; H04M 1/60

(52) U.S. Cl. CPC H04R 1/1041; H04W 76/10; H04R 1/1016; H04R 1/1033; H04R 1/1025; H02J 7/0045; H04R 1/1075; H04M 19/047; H04M 1/6066; H04R 2420/07; H04R 1/08

(57) ABSTRACT

A wireless earbud system includes a neckband having a first end and a second end defining a curved member configured to contour to a neck of a wearer. A first earbud includes a first speaker and a first ear tip. A second earbud includes a second speaker and a second ear tip. A first opening disposed in the first end of the neckband defines a first compartment configured to receive and store the first ear tip of the first earbud. A second opening disposed in the second end of the neckband defining a second compartment configured to receive and store the second ear tip of the second earbud. The neckband, first earbud, and second earbud are in wireless communication with an external device, such that a user can receive incoming communications from the external device.

### CROSS REFERENCE TO RELATED APPLICATIONS

This application claims the benefit of U.S. Provisional Application No. 62/937,466 filed on Nov. 19, 2019. The above identified patent application is herein incorporated by reference in its entirety to provide continuity of disclosure.

### BACKGROUND OF THE INVENTION

The present invention relates to a wireless earbud system. More specifically, the present invention provides a wireless earbud system that includes a wearable neckband for securing, charging, and storing a pair of wireless earbuds in an accessible manner.

Many individuals utilize wireless earbuds to listen to audio and to facilitate hands free communication via a mobile phone or similar external device. Wireless earbuds require their own internal power supplies to power the wireless transceivers that receive the wireless information from the external device, which is converted to sound emitted through the earbud's speakers. It can be difficult to ensure that the wireless earbuds maintain an adequate battery charge. Some devices include charging cases that receive the wireless earbuds. However, these cases are often difficult to keep track of and can be easily misplaced. Some accessory devices exist that can secure the cases to a person or other article, but they are costly and do not always function properly. While some wireless speaker-type wearable devices include a neckband, the in-ear part of the earbuds are typically statically and immovably attached to the ends neckband, so the user can only wear the earbuds with the attached neckband wrapping around the back of the head, which may not be desired. While some wearable attachments for earbuds exist, the manner in which the earbuds are attached leave the ear tip portion of the earbuds exposed. This can lead to the ear tips becoming damaged and requiring replacement.

The present invention differs from wireless earbuds in the known art in that the present invention provides a system that includes a neckband configured to be worn about the user's neck, which has compartments for securing the wireless earbuds to the neckband that allow the earbuds to separate and be worn detached from the physical ends of the neckband. Further, the compartments in the ends of the neckband allow the earbuds to be stored in a conveniently accessible manner while protecting the ear tip portion of the earbud from exposure.

In light of the devices disclosed in the known art, it is submitted that the present invention substantially diverges in design elements from the prior art and consequently it is clear that there is a need in the art for an improvement to existing wireless earbuds. In this regard the present invention substantially fulfills these needs.

### SUMMARY OF THE INVENTION

In view of the foregoing disadvantages inherent in the known types of vending machines now present in the prior art, the present invention provides a wireless earbud system that secures the earbuds to a wearable neckband for accessible storage in a manner that protects the ear tips of the earbuds. In one embodiment, the wireless earbud system includes a neckband having a first end and a second end defining a curved member configured to contour to a neck of a wearer. A first earbud includes a first housing and a first ear tip removably secured to the first housing. A second earbud includes a second housing and a second ear tip removably secured to the second housing.

A first opening is disposed in the first end of the neckband defining a first compartment configured to receive and store the first ear tip of the first earbud. A second opening is disposed in the second end of the neckband defining a second compartment configured to receive and store the second ear tip of the second earbud. The first earbud and the second earbud are in wireless communication with a control unit disposed within the neckband, such that the neckband, the first earbud, and the second earbud are in wireless communication with an external device.

One object of the present invention is to provide a wireless earbud system that includes a neckband with a vibration mechanism that indicates incoming communications from a wirelessly connected external device.

Another object of the present invention is to provide a wireless earbud system having a wearable neckband with a storage system that stores the earbuds when they are not in use in a manner that encloses the ear tips of the ear buds, preventing them from being damaged.

A further object of the present invention is to provide a wireless earbud system as described above, wherein removing the ear tips from their respective compartments in the neckband automatically transmits a communication from a wirelessly connected external device to the earbuds when the neckband detects an incoming communication is received by the external device.

Yet another object of the present invention is to provide a wireless earbud system including a first tether that connects the first earbud to the neckband, and a second tether that connects the second earbud to the neckband, for additional security and to prevent the earbuds from becoming misplaced.

Other objects, features, and advantages of the present invention will become apparent given the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top plan view an embodiment of the wireless earphone system with external tethers and the earbuds removed from their respective compartments.

FIG. 2 shows a top plan view an embodiment of the wireless earphone system with external tethers and the earbuds secured within their individual compartments.

FIG. 3 shows a side elevation view of the wireless earphone system showing the external components of the neckband.

FIG. 4 shows a top plan view an embodiment of the wireless earphone system with internal tethers and the earbuds secured within their individual compartments.

FIG. 5 shows a block diagram of the components of an embodiment of the wireless earphone system.

### DETAILED DESCRIPTION OF THE INVENTION

Reference is made herein to the attached drawings. Like reference numerals are used throughout the drawings to depict like or similar elements of the retractable floor cover. For the purposes of presenting a brief and clear description of the present invention, the preferred embodiment will be discussed as used for providing a wireless earbud system that can support the earbuds in a stored configuration within a wearable neckband. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “an external device”, “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “external device” refers to any computing device that is capable of wirelessly communicating with the present invention. The external device can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such external devices can also combine custom hard-wired logic, ASICs, or FPGAs with custom programming to accomplish the technique and other features of the present disclosure. The external devices can include desktop computer systems, laptops, cell phones, tablets, networking devices, or any other device that incorporates hard-wired and/or program logic to implement the techniques and other features of the present disclosure. In the interest of economy of disclosure, the present application may refer to a “mobile phone” as one example of an external device.

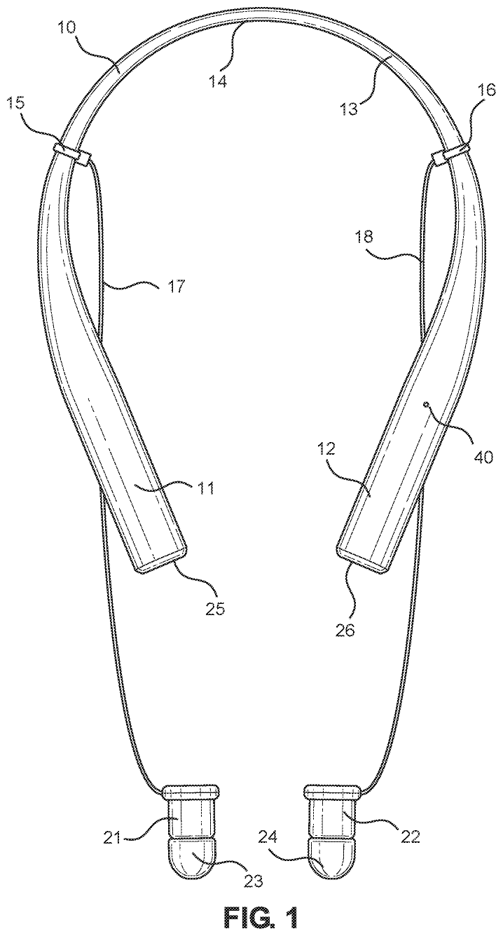

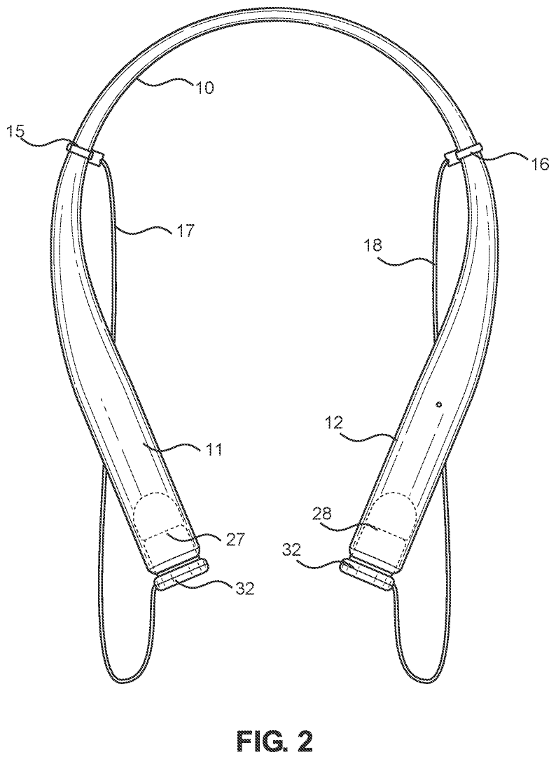

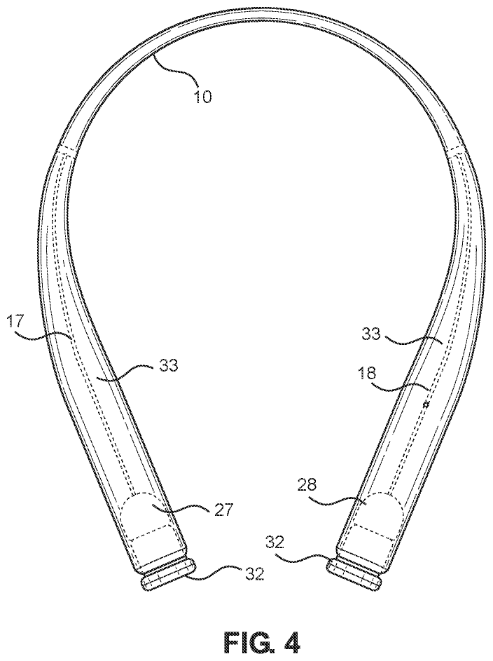

Referring now to FIG. 1, there is shown a top plan view an embodiment of the wireless earphone system with external tethers and the earbuds removed from their respective compartments. The system generally includes a neckband 10 having a first end 11 and a second end 12 extending from opposing ends of a curved middle portion 13. This defines an inwardly curving neckband with an inner neck connecting edge 14 that contours to the wearer's neck for comfort. In the illustrated embodiment, the neckband includes wider first and second ends 12, 13 that taper to a narrower middle portion 13. This improves comfort and provides adequate space for the compartments that store the earbuds, as shown in FIGS. 2 and 4. The neckband 10 can be rigid with slight flexibility or can be made from materials that allow it to be moldable or formable to a particular shape, allowing the user to adjust the fit of the neckband 10 for comfort. Additionally, some embodiments may include neckbands 10 with padding or other attachments for improving comfort for the wearer.

A first earbud 21 includes a first ear tip 23, and a second earbud 22 includes a second ear tip 24. In the illustrated embodiment, the ear tips 23, 24 are flexible and removably attached to the earbuds 21, 22, such that the user can attach different shapes, sizes, and types of ear tips 23, 24 to suit their comfort. In alternate embodiments, the ear tips 23, 24 can be fixedly attached or integrated with the housing of the earbud 21, 22. In the illustrated embodiment, a first tether 17 connects the first earbud 23 to the neckband 10, and a second tether 18 connects the second earbud 22 to the neckband 10. In the embodiment shown in FIGS. 1-3, the first and second tethers 17, 18 are attached to external connectors 18, 19 that are affixed to the neckband 10. In some embodiments, the external connectors 18, 19 are static and do not move. In other embodiments, the external connectors 18, 19 are configured to be adjustable such that they can be positioned anywhere along the length of the neckband 10. Still, in other embodiments, such as the embodiment shown in FIG. 4, the tethers 17, 18 are connected to the neckband 10 within an interior volume 33 of the neckband 10, allowing the tethers to be hidden when the earbuds 21, 22 are stored in their respective compartments 27, 28. Still, other embodiments may forgo the inclusion of the tethers 17, 18.

Referring now to FIGS. 2 and 4, there is shown a top plan view an embodiment of the wireless earphone system with external tethers and the earbuds secured within their individual compartments and a top plan view an embodiment of the wireless earphone system with internal tethers and the earbuds secured within their individual compartments, respectively. While these embodiments are shown with tethers 17, 18, other embodiments may not include the tethers 17, 18. A first opening 25 disposed in the first end 11 of the neckband 10 defines a first compartment 27 configured to receive and store the first ear tip 23 of the first earbud 21, and second opening 26 disposed in the second end 12 of the neckband 10 defines a second compartment 28 configured to receive and store the second ear tip 24 of the second earbud 22. In some embodiments, the earbuds 22, 23 include a rear lip 32 that extends outwardly from the compartments 27, 28 when the ear tips 23, 24 are secured therein. This allows the compartments 27, 28 to enclose and protect the ear tips 23, 24, while the lip 32 is exposed, forming a type of handle so the user can easily grasp the earbuds 22, 23 for insertion or removal from the compartments 27, 28.

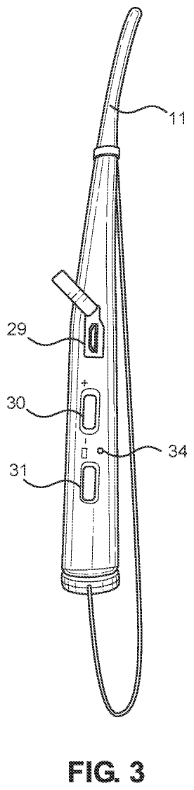

Referring now to FIG. 3, there is shown a side elevation view of the wireless earphone system showing the external components of the neckband. The neckband 10 includes control buttons that allow the user to control the external device, which is the source of audio for the earbuds 21, 22, as well as allowing for control of the earbuds themselves. For example, the neckband 10 can control playback selections from the audio source of the external device. In the illustrated embodiment, the neckband 10 includes a pair of volume buttons 30, 31 that can be utilized to adjust the volume of the sound that is played through the earbuds 21, 22. The neckband 10 also includes a charging port 29, shown here as a USB port, which is electrically and operably connected to a power supply, such as a rechargeable battery disposed within the neckband 10, allowing the user to easily charge the neckband 10 battery via an external power source, such as a wall outlet connection for example. Further, in the shown embodiment, the neckband 10 includes an indicator light 34 that can be utilized to indicate battery status, connection status, or convey other information to the user. Other embodiments of the present invention may include various additional buttons, controls, connectors, and indicator lights.

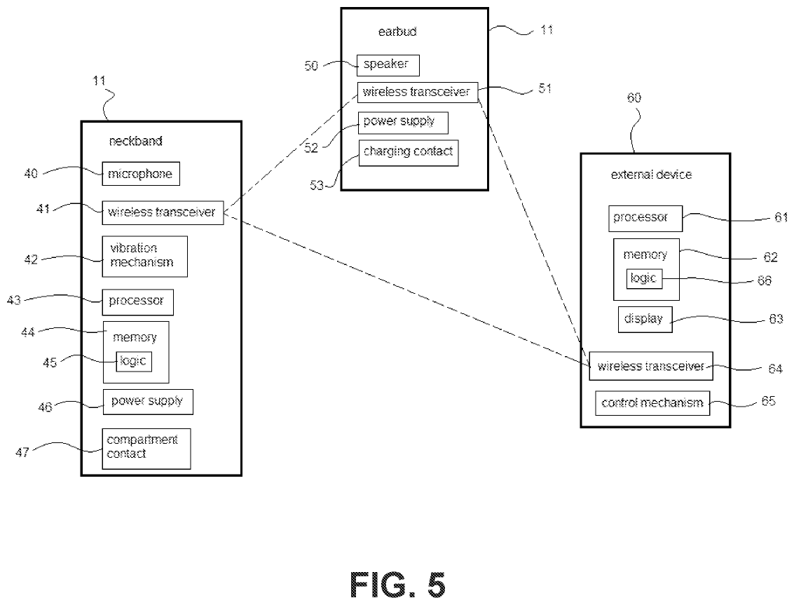

Referring now to FIG. 5, there is shown a block diagram of the components of an embodiment of the wireless earphone system. The wireless earbud system functions entirely wirelessly, such that a wireless transceiver 51 of each of the earbuds 21, 22 is in wireless communication with a wireless transceiver 41 of the neckband 10, and with a wireless transceiver 64 of an external device 60. In this way, the neckband 10 and the earbuds 21, 22 are in continuous wireless communication with the wireless transceiver 64 of the external device 60. The external device 60 will typically include a processor 61, a memory 62, a display 63, a wireless transceiver 64, and a control mechanism 65, such as buttons or a touchscreen, for example. The external device 60 can be utilized to adjust parameters of the earbud system, such as volume, for example, as well as provide an audio source for the system.

In the shown embodiment, the neckband 10 further includes a microphone 40 for recording and transmitting sound for the user when they receive a phone call or similar communication from the external device 60. The neckband 10 further includes a vibration mechanism 42 disposed within the neckband 10, wherein the vibration mechanism 42 is configured to activate upon detection of a communication being received by a wirelessly connected external device 60, allowing the user to be silently notified of the incoming communication.

Each earbud includes a speaker 50, a wireless transceiver 51, a power supply 52, and a charging contact 53 for charging the power supply 52. In the shown embodiment, the neckband's 10 earbud compartments include corresponding contacts 47. When the earbuds are stored within their compartments, the charging contact 53 touches the corresponding contact 47 of the neckband 10, which electrically connects the neckband power supply 46 to the earbud power supply 52. In this way, the neckband power supply 46 is utilized as a power source for recharging the earbud internal power supply 52.

In some embodiments, the neckband 10 includes an internal processor 43, memory 44, and logic 45 that allow it to initiate automatic operation of the system in particular circumstances. As one example, when the neckband 10 and the earbuds are connected to the external device 60, the logic 45 can detect incoming communications that are received by the external device 60. The logic 45 can then cause the system to automatically establish audio and microphone streaming between the external device 60 and the earbuds when the earbuds are removed from their compartments. In such an example, the disconnection of the electrical contacts 47, 53 would indicate removal of the earbuds from their compartments and initiate the connection between the external device 60 and the earbuds. In this way, a phone call can be automatically answered when the user removes the earbuds from their compartments.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wireless earbud system comprising:
a neckband having a first end and a second end defining a curved member configured to contour to a neck of a wearer;
a first earbud having a first ear tip attached to a first end thereof;
a second earbud having a second ear tip attached to a first end thereof;
a first opening disposed in the first end of the neckband defining a first compartment configured to receive and store the first ear tip of the first earbud;
a second opening disposed in the second end of the neckband defining a second compartment configured to receive and store the second ear tip of the second earbud;
wherein a wireless transceiver of the first earbud and a wireless transceiver of the second earbud are in wireless communication with a wireless transceiver of the neckband, such that the neckband, the first earbud, and the second earbud are in wireless communication with a wireless transceiver of an external device.

2. The wireless earbud system of claim 1, further comprising:
a first tether having a first end attached to a second end of the first earbud and a second end attached to the neckband; and
a second tether having a first end attached to a second end of the second earbud and a second end attached to the neckband.

3. The wireless earbud system of claim 2, wherein the second end of the first tether is affixed to a first external connector attached to the neckband, and wherein the second end of the second tether is affixed to a second external connector attached to the neckband.

4. The wireless earbud system of claim 3, wherein the first external connector and the second external connector are adjustably positioned on the neckband.

5. The wireless earbud system of claim 2, wherein the first tether and the second tether are disposed within an interior volume of the neckband.

6. The wireless earbud system of claim 1, wherein the first earbud and the second earbud each comprises a rear lip that extends outwardly from the first compartment and the second compartment to form a gripping handle when the first earbud and the second earbud are stored in the first compartment and the second compartment, respectively.

7. The wireless earbud system of claim 1, further comprising a power supply that includes a rechargeable battery disposed within the neckband and operably connected to a charging port disposed on the neckband.

8. The wireless earbud system of claim 1, further comprising a vibration mechanism disposed within the neckband, wherein the vibration mechanism is configured to activate upon detection of a communication being received by a wirelessly connected external device.

9. The wireless earbud system of claim 1, further comprising one or more control buttons disposed on the neckband configured to control one or more parameters of a connected external device and further configured to control one or more parameters of the first earbud and the second earbud.

10. The wireless earbud system of claim 1, wherein the first earbud includes a first power supply and the second earbud includes a second power supply, wherein the neckband power supply is configured to electrically connect to the first earbud power supply when the first earbud power supply is secured within the first compartment and configured to electrically connect to the second earbud power supply when the second earbud power supply is secured within the second compartment.

11. A wireless earbud system comprising:
a neckband having a first end and a second end defining a curved member configured to contour to a neck of a wearer;
a microphone;
a first earbud having a first speaker and a first ear tip attached to a first end thereof;
a second earbud having a second speaker and a second ear tip attached to a first end thereof;
a first opening disposed in the first end of the neckband defining a first compartment that removably stores the first ear tip of the first earbud;
a second opening disposed in the second end of the neckband defining a second compartment that removably stores the second ear tip of the second earbud;
a processor;
a non-transitory computer readable medium operatively connected to the processor;
a logic stored in the non-transitory computer readable medium that, when executed by the processor, causes the wireless earbud system to perform a method, the method comprising:
wirelessly connecting the neckband, the first earbud, and the second earbud to an external device;
detecting an incoming communication received by the external device;
if the first earbud or the second earbud is removed from the first compartment or the second compartment, then transmitting the communication to the first earbud or the second earbud.

12. The wireless earbud system of claim 11, further comprising:
a first tether having a first end attached to a second end of tine first earbud and a second end attached to the neckband; and
a second tether having a first end attached to a second end of the second earbud and a second end attached to the neckband.

13. The wireless earbud system of claim 12, wherein one end of the first tether is affixed to a first external connector attached to the neckband, and wherein one end of the second tether is affixed to a second external connector attached to the neckband.

14. The wireless earbud system of claim 13, wherein the first external connector and the second external connector are adjustably positioned on the neckband.

15. The wireless earbud system of claim 12, wherein the first tether and the second tether are disposed within an interior volume of the neckband.

16. The wireless earbud system of claim 11, wherein the first earbud and the second earbud each comprises a rear lip that extends outwardly from the first compartment and the second compartment to form a gripping handle when the first earbud and the second earbud are stored in the first compartment and the second compartment, respectively.

17. The wireless earbud system of claim 11, further comprising a rechargeable battery disposed within the neckband and operably connected to a charging port disposed on the neckband.

18. The wireless earbud system of claim 11, further comprising a vibration mechanism disposed within the neckband, wherein the vibration mechanism is configured to activate upon detection of a communication being received by a wirelessly connected external device.

19. The wireless earbud system of claim 11, further comprising one or more control buttons disposed on the neckband configured to control one or more parameters of a connected external device and further configured to control one or more parameters of the first earbud and the second earbud.

20. The wireless earbud system of claim 11, wherein the first earbud includes a first power supply and the second earbud includes a second power supply, wherein the neckband power supply is configured to electrically connect to the first earbud power supply when the first earbud power supply is secured within the first compartment and configured to electrically connect to the second earbud power supply when the second earbud power supply is secured within the second compartment.
